(19) United States
(12) Patent Application Publication
(10) Pub. No.: US 2025/0216896 A1
(43) Pub. Date: Jul. 3, 2025

(54) MOUNT AND CABLE MANAGEMENT FOR HEAD-MOUNTABLE DEVICE

(71) Applicant: Apple Inc., Cupertino, CA (US)

(72) Inventors: Paul X. Wang, Cupertino, CA (US); Ivan S. Maric, Campbell, CA (US); Kristine S. Atom, Sunnyvale, CA (US); Yuhao Pan, Sunnyvale, CA (US)

(21) Appl. No.: 18/905,385

(22) PCT Filed: May 1, 2023
(86) PCT No.: PCT/US2023/020627

§ 371 Date: Oct. 3, 2024

Related U.S. Application Data
(60) Provisional application No. 63/364,006, filed on May 2, 2022.

(51) Int. Cl. G06F 1/16

(52) U.S. Cl. CPC G06F 1/163

(57) ABSTRACT

A head-mountable device can include a display, a support attached to the display and configured to retain the display on a user's head, and an attachment feature configured to removably couple a battery to the support, the attachment feature positioned opposite the display to at least partially counterbalance the display.

### CROSS-REFERENCE TO RELATED APPLICATION(S)

This application is a national stage filing based off of PCT Application No. PCT/US2023/020627, filed 2023 May 1, and entitled “MOUNT AND CABLE MANAGEMENT FOR HEAD-MOUNTABLE DEVICE,” which claims priority to U.S. Provisional Patent Application No. 63/364,006, filed 2 May 2022, and entitled “MOUNT AND CABLE MANAGEMENT FOR HEAD-MOUNTABLE DEVICE,” the entire disclosures of which are hereby incorporated by reference.

### FIELD

The described embodiments relate generally to head-mountable devices. More particularly, the present embodiments relate to an attachment feature for mounting an accessory to a head-mountable device and a cable management system.

### BACKGROUND

A primary challenge when developing head-mountable displays, particularly head-mountable displays that have small form factors, is achieving a suitable battery life while still maintaining functionality and a socially acceptable shape and size. Performing the necessary computing functions and extended use of the head-mountable display may deplete the battery life more quickly than desirable. Given the power needs of modern head-mountable displays and current battery technology, a user may be required to remove the head-mountable display to charge the battery several times a day, often interrupting use, and causing inconvenience to the user. Accordingly, there is a need for a head-mountable assembly including an auxiliary or supplementary battery that can supplement a primary battery of the device. Including an auxiliary battery comes with the additional challenge of cable management. Thus, there is a need for a head-mountable assembly having a cable management system as well.

An additional challenge arises from the unbalanced weight distribution experienced by a user while wearing the head-mountable display. The nature of head-mountable displays requires that they be worn in front of the user's eyes meaning that the center of mass of the HMD is often positioned in front of the user's face. This can result in the user experiencing muscle fatigue or neck strain due to the rotational torque put on the user's head and neck. Thus, there is a need for a head-mountable device with improved balance to reduce user fatigue when using the device.

### SUMMARY

According to some aspects of the present disclosure, a head-mountable assembly can include a display unit, a retention band, a mount attachable to the retention band, the mount being movable relative to the retention band, and an accessory attachable to the mount, the accessory being movable by the mount.

In some examples, the accessory can include a battery. The accessory can be magnetically attached to the mount. The mount can be extendable to increase a distance between the display unit and the accessory. The mount can include an output component. The mount can be integrally formed with the retention band. The mount can be integrally formed with the accessory.

According to some aspects, a head-mountable device can include a display, a support attached to the display and configured to retain the display on a user's head, and an attachment feature that removably couples a battery to the support, the attachment feature positioned opposite the display.

In some examples, the battery can include a supplemental battery. The attachment feature can be removable from the support. The attachment feature can be movable to adjust a position of the battery. The attachment feature can include a cable management feature to retain a cable of the battery.

In some examples, the attachment feature can include a first electrical connector to establish an electrical connection with the battery, and a second electrical connector to establish an electrical connection with the display. The attachment feature can define an internal volume that houses an electrical component. The attachment feature can include an over-the-head support.

According to some aspects, a mount for an auxiliary battery of a head-mountable device can include a cable management system, a first attachment interface to attach the mount to a retention band of the head-mountable device, and a second attachment interface to attach the auxiliary battery to the mount.

In some examples, the cable management system can include a retraction device that automatically retracts the cable. The second attachment interface can be rotatable and translatable relative to the first attachment interface. At least one of the first attachment interface or the second attachment interface can include a magnetic attachment. The second attachment interface can attach to the auxiliary battery in response to the auxiliary battery being positioned against the mount.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic block diagram of a head-mountable assembly.

FIG. 2 shows a top view of a head-mountable assembly.

FIG. 3 shows a side view of a head-mountable assembly.

FIG. 4 shows a side view of a head-mountable assembly.

FIG. 5 shows a side view of a head-mountable assembly.

FIG. 6A shows a top view of an attachment feature.

FIG. 6B shows a side view of an attachment feature.

FIG. 6C shows a side view of an attachment feature.

FIG. 6D shows a rear perspective view of a head-mountable assembly.

FIG. 7 shows a top view of a cable management system.

FIG. 8A shows a side view of a head-mountable assembly.

FIG. 8B shows a rear perspective view of a head-mountable assembly.

FIG. 8C shows a top view of a head-mountable assembly.

FIG. 8D shows a perspective view of a mount.

FIG. 9 shows a top view of a head-mountable assembly.

FIG. 10 shows a side view of a head-mountable assembly.

FIG. 11 shows a cross-sectional side view of a cable management system.

FIG. 12 shows a top view of a head-mountable assembly.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a mount (also referred to as a holder or attachment feature) that is attachable to a support, such as a headband or retention band, of a head-mountable device (HMD). The disclosed mount solves fundamental challenges faced by conventional HMDs by providing at least the following advantages. Firstly, the mount allows an accessory, such as an auxiliary battery, to be conveniently attached to the HMD. Secondly, the mount addresses the problem of an unbalanced weight distribution experienced by a user while wearing the HMD. Lastly, the mount can include a cable management system or cable organizer that retains a cable or wire, thereby eliminating or reducing slack in the cable. Each of these benefits are discussed in detail.

Given the power needs of head-mountable displays and current battery technology, a user may be required to charge the battery of the HMD several times a day, often interrupting use, and causing inconvenience to the user. The present disclosure provides means for an auxiliary or supplementary battery to be mounted to a headband of the HMD and to establish an electrical communication with the HMD. Although the focus of the disclosure relates to the accessory being an auxiliary battery, it will be understood that the mount can be used for a variety of removable components and accessories.

The mount can include a first attachment interface for coupling with the headband, and a second attachment interface for coupling with the accessory. The attachment interfaces can be mechanical (i.e., physical) and/or magnetic. In some examples, the attachment interfaces are actuated in response to an action (e.g., placing the accessory against the mount). In some examples, the mount can be permanently integrated into the headband and/or the accessory. Further details regarding the attachment interfaces are provided below.

The mount can also provide the advantage of a head-mountable device with improved balance to reduce user fatigue when using the device. The nature of head-mountable displays often requires that the bulk of the device is worn in front of the user's eyes, meaning that the center of mass of the HMD is often positioned in front of the user's face, off-axis of the user's head. This can result in the user experiencing muscle fatigue or neck strain due to the rotational torque put on the user's head and neck. The mount addresses this problem by providing a counterbalance to offset the weight of the HMD and bring the center of mass toward the center of the user's head.

In some examples, the weight of the accessory held by the mount can be approximately equal to the weight of the HMD. Thus, a center of mass of the HMD assembly can be shifted from the user's face to the center of the user's head, thereby alleviating neck strain. In some examples, the mount is articulable or movable to change the position and orientation of the accessory, which can likewise change the center of mass of the assembly. In some examples, the weight of the mount itself can at least partially counterbalance the weight of the HMD.

In some examples, the mount includes a cable management system. For instance, a cable can be wrapped around the mount in order to take up the slack in the cable. More specifically, the cable can be wrapped around a central shaft of the mount. In some examples, the mount includes one or more hangers or pegs around which the cable can be wound. Because the mount can position the accessory away from the user's head, thereby creating a gap between the accessory and the user's head, a volume may exist for the cable to be inserted. In some examples, the mount can include a housing that defines an internal volume or cubby for the cable to be housed. In some examples, the assembly can include a retraction device that can reel or wind up the cable. For example, the mount can include a retraction device that reels up the cable inside a housing of the mount. In some examples the retraction device includes a spool that can collect the cable. The cable management system can be incorporated into the HMD, the retention band, the mount, and/or the accessory. The cable management system can be located internally or externally. Further details regarding cable management system are provided below.

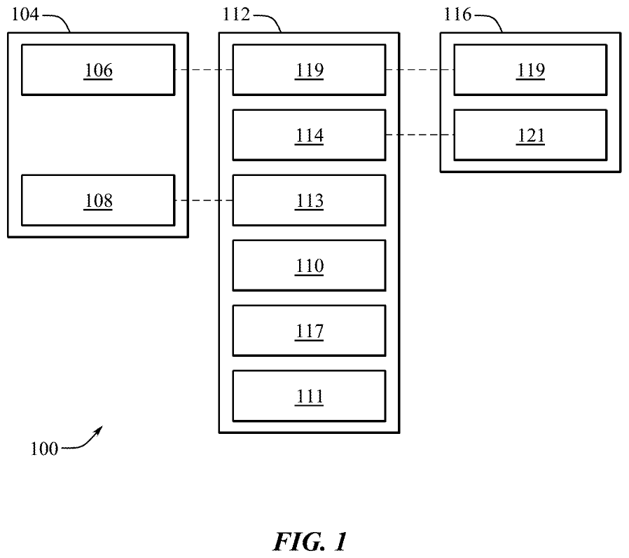

These and other embodiments are discussed below with reference to FIGS. 1-12. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows a schematic block diagram of a head-mountable assembly (assembly 100.) The assembly 100 can include a head-mountable display (HMD 104), a mount 112, and an accessory 116. In some examples, the assembly 100 can be modular (i.e., the HMD 104, the mount 112, and the accessory 116 can be detachable and separable from one another). In some examples, the assembly 100 can be at least partially a unitary device (i.e., one or more of the HMD 104, the mount 112, or the accessory 116 can be integrally formed and configured to be permanently attached to one another).

It will be understood that only select components are shown and described in FIG. 1 for simplicity. The assembly 100 is not limited to these components and may include additional components not shown or described herein.

The HMD 104 (also referred to as a display or display unit) can include a power source, such as a battery 106, and an attachment interface 108. The battery 106 can be a primary battery and can be operative to electrically couple with and supply power to the components of the HMD 104, the mount 112, and/or the accessory 116. The battery 106 can be a rechargeable battery, such as a lithium-ion polymer battery. The battery 106 can be completely housing within a housing of the HMD 104. Although FIG. 1 shows the battery 106 as a single unit, multiple batteries can be used as the main power source of the HMD 104.

The attachment interface 108 (also referred to as a headband, support, and retention band) can attach or couple with the mount 112. In some examples, the attachment interface 108 is a band, strap, belt, arms, or other form of support that secures the HMD 104 to a user's head. The HMD 104 can include a display, a processor, a user interface, and other components and features not explicitly shown in FIG. 1. Further details of the assembly 100 are provided below.

The mount 112 (also referred to as a holder or attachment feature) can include an electrical interface 119 for establishing an electrical connection between the mount 112 and the HMD 104. Specifically, the electrical interface 119 can be in electrical communication with the battery 106 of the HMD 104. The electrical interface 119 can also be in direct communication with other components of the HMD 104. Power and/or data can be transferred between the HMD 104 and the mount 112. For example, power can be transferred from the mount 112 to the battery 106 to charge the battery 106. The electrical interface 119 can also transfer power/data from the HMD 104 to the mount 112.

In some examples, the mount 112 includes a first coupler or attachment interface 114 that engages, attached, or couples with the accessory 116. The first coupler 114 can releasably couple with the accessory 116. As described in greater detail below, the first coupler 114 can include any suitable attachment mechanism for connecting to the accessory 116. The first coupler 114 can be a mechanical and/or magnetic attachment interface. In some examples, the first coupler 114 is a recess or slot define by the mount 112 that receives and releasably secures the accessory 116 to the mount 112.

In some examples, the mount 112 includes a second coupler or attachment interface 113 that engages, attached, or couples with the HMD 104. The second coupler 113 can releasably or fixedly couple with the HMD 104. As described in greater detail below, the second coupler 113 can include any suitable attachment mechanism for connecting to the HMD 104. The second coupler 113 can be a mechanical and/or magnetic attachment interface. In some examples, the second coupler 113 can include a recess or slot defined by the mount 112 that receives and releasably secures the HMD 104 to the mount 112. In some examples, the second coupler 113 can be a strap or belt, such as Velcro that wraps around a head retention band of the HMD 104. Further details regarding attachment interfaces and couplers are provided below.

In some examples, the mount 112 can include an output component 110. Although only one output component 110 is shown in FIG. 1, it will be understood that the output component 110 can include multiple physically distinct or combined outputs. The output component can include a variety of electrical components that produce an output (e.g., audio component, light module, haptic component, etc.) The output component 110 can alert the user to a status or state of the HMD 104, the mount 112, and/or the accessory 116. In some examples, the output component 110 can signal whether the mount 112 is connected (physically and/or electrically) to the HMD 104 or the accessory 116. Further details regarding output components are provided below with reference to FIG. 5.

In some examples, the mount 112 can include a cable manager 117 (also referred to as a cable management system or cable organizer). The cable manager 117 can organize, retain, or otherwise secure a cable or wire of the assembly 100. For example, the accessory 116 can be in direct electrical communication with the HMD 104 via a cable or wire. The cable can be long, in order to accommodate for instances when the accessory is not proximate the HMD 104 (i.e., not in the mount 112). The length of the cable can be cumbersome, making it difficult to use the HMD 104. Thus, the cable manager 117 can be used to orderly retain and store the cable. Cable management systems are discussed in greater detail below with reference to FIGS. 7-12.

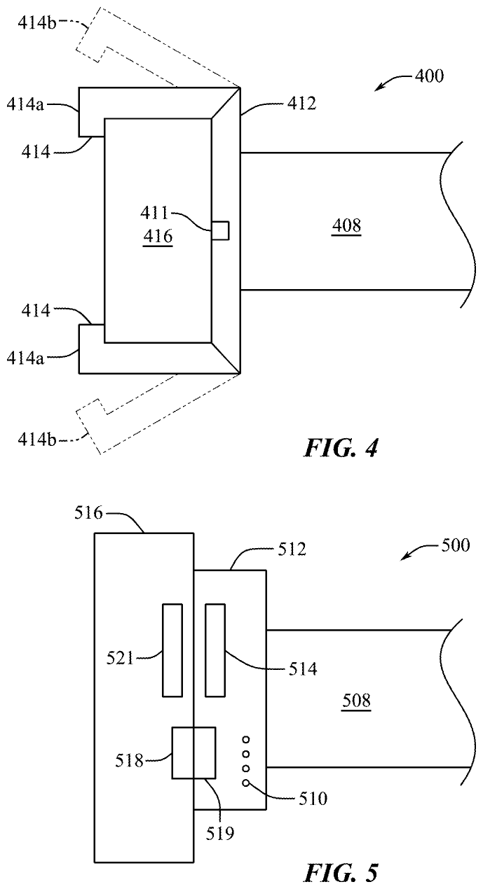

In some examples, the mount 112 can include a sensor unit 111. The sensor unit 111 can detect or determine one or more aspects of the operational environment or physical environment of the assembly 100. Although only one sensor unit 111 is shown in FIG. 1, it will be understood that the sensor unit 111 can include multiple physically distinct or combined sensors. For example, sensor unit 111 can include one or more of a contact sensor, a pressure sensor, a proximity sensor, a camera, a microphone, an infrared receiver, a global positioning system unit, a gyroscopic sensor, an accelerometer, a capacitive sensor, a biometric sensor, a magnetometer, a radar unit, a lidar unit, an ultrasound unit, a temperature sensor, or any other sensor capable of detecting or determining one or more aspects or conditions of the operational environment of the electronic device 201. In a specific example, the sensor unit 111 can determine whether the accessory 116 is near or attached to the mount 112. The sensor unit 111 can be operatively coupled to the mount 112 to cause the mount 112 to perform one or more actions. For example, upon determining that a user is attempting to attach the accessory 116 to the mount 112, the sensor can produce a signal that triggers the first coupler 114 to attach to the accessory. In some examples, the mount 112 includes an actuator that reacts to placement of the accessory 116 in/on the mount, causing the first coupler 114 to secure the accessory 116. Example sensor units are discussed in greater detail below with reference to FIG. 4.

The accessory 116 can include an electrical interface 119 and an attachment interface 121. The attachment interface 121 can be configured to couple with the first coupler 114 on the mount 112. In some examples, the attachment interface 121 is merely the exterior of the accessory 116, but in some examples, the attachment interface 121 is mechanical and/or magnetic attachment mechanism. The electrical interface 119 can establish an electrical connection with the electrical interface 113 of the mount 112. The electrical interface 119 can be a direct electrical connection (e.g., an Orion connection). In some examples, the electrical interface 119 can establish an electrical connection directly with the HMD 104. In some examples, the electrical interface 119 can include a cable or wire that connects to the HMD 104.

In some examples, the accessory 116 can include or be a supplemental or auxiliary battery. The auxiliary battery 116 can be a rechargeable battery, such as lithium-ion polymer battery. The auxiliary battery 116 can provide power to one or more components of the HMD 104. In some examples, the auxiliary battery 116 can be used to charge the primary battery 106. In some examples, the primary battery 106 can charge the auxiliary battery 116.

The accessory 116 can be a companion device that communicates with the HMD 104 via a communications link. The communications link can be a physical connection, such as an electrical wire, or can be a wireless connection, such as Bluetooth, Wi-Fi, proximity sensors, etc. The companion electronic device 116 can be a remote, or a personal computing device such as a smart phone, a smart watch, a tablet, or any other form of electronic device.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Further, for simplicity, reference numbers ending in like or similar numbers, but with changes in the hundreds place may refer to the same or similar component from a different embodiment or figure. For example, HMD 104 and HMD 204 may share many of the same characteristics and components, while remaining distinct embodiments.

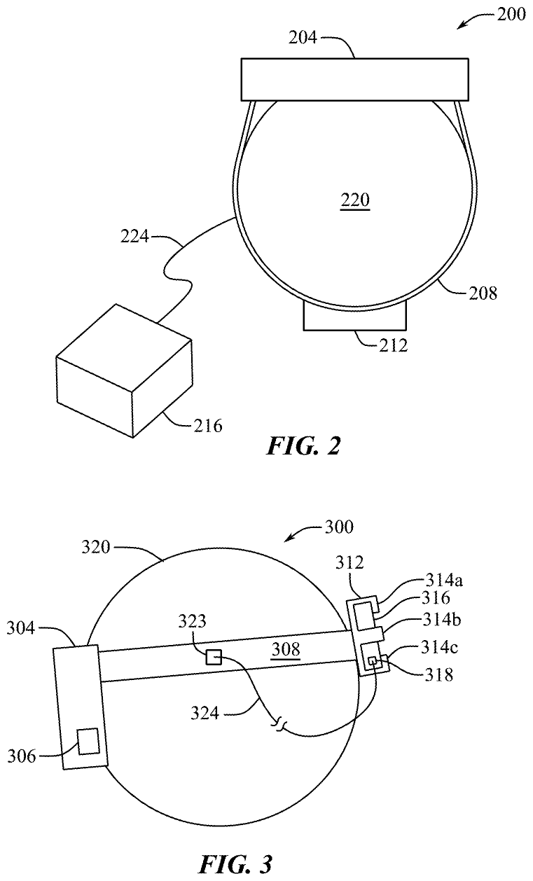

FIG. 2 shows a top view of a head-mountable assembly 200. The assembly 200 can be substantially similar to, including some or all of the features of, the head-mountable assemblies described herein, including assembly 100. The assembly 200 can include an HMD 204, a headband or retention band 208, a mount 212, and an accessory 216.

The HMD 204 can include a display (not shown in FIG. 2) and a frame attached to the display. In some examples, the display includes an opaque, translucent, transparent, or semi-transparent screen, including any number lenses, for presenting visual data. The frame can at least partially border one or more edges of the display. In some examples, the frame can be configured to contact a user's face or head 220. In some examples, the frame blocks outside light and limits the peripheral view of the user. Various components of the HMD 204 can be housed within the frame. For example, the hardware and electronics which allow functionality of the HMD can be housed within the frame.

The assembly 200 can be worn on the user's head 220 such that the HMD 204 is positioned over the user's face and disposed over one or both of the user's eyes. The HMD 204 can be connected to the retention band 208. In some examples, the retention band 208 can be positioned against the side of a user's head 220 and in contact therewith. In some examples, the retention band 208 can be at least partially positioned above the user's ear or ears. In some examples, the retention band 208 can be positioned adjacent to the user's ear or ears. The retention band 208 can extend around the user's head 220. In this way, the HMD 204 and the retention band 208 can form a loop that can retain the assembly 100 on the user's head 220. It should be understood, however, that this configuration is just one example of how the components of a modular wearable device can be arranged, and that in some examples, a different number of connector straps and/or retention bands can be included. Although the particular component 204 can be referred to as an HMD, it should be understood that the terms HMD, HMD device, and/or HMD system can be used to refer to the assembly as a whole.

As described herein, the weight of the HMD 204 near the front of the user's head 220 can cause neck strain due to rotational torque on the user's neck. A solution to this problem is to use the accessory 216 as a counterbalance by attaching the accessory 216 to the mount 212. Because the mount 212 can be positioned opposite the HMD 204 (i.e., on the back of the user's head 220), by positioning the accessory 216 opposite the HMD 204, the center of mass of the assembly 200 can shift from the front of the user's head to the middle or center of the user's head, thereby reducing neck strain and muscle fatigue. In some examples, the weight of the HMD 204 and the weight of the accessory 216 is substantially similar. For example, each the HMD 204 and the accessory 216 can weigh approximately 300 grams. In some examples, the weight of the accessory 216 combined with the weight of the mount 212 is roughly equal to the weight of the HMD 204. In some examples, the weight of just the mount 212 can be roughly equal to the weight of the HMD 204.

The accessory 216 can include or be an auxiliary battery that provides power to the HMD 204 via a cable 224. In some examples, the cable 224 can establish a data or communications link between the HMD 204 and the accessory 216. In some examples, the retention band 208 itself can be the attachment interface for attaching the mount 212 to the retention band 208. In other words, the mount 212 can be retrofit onto existing retention bands without requiring modification to the existing retention bands. In some examples, the retention band 208 include a separate component for coupling with the mount 212. In some examples, the mount 212 is incorporated into the retention band 208 as an integral component of the retention band 208. In some examples, the fabric of the retention band 208 secures the mount 212. For instance, the retention band can act as a sleeve or sheath for at least some of the mount 212. Further details regarding the mount 212 and potential means of attachment between the retention band 208 and the accessory 216 are described below.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

FIG. 3 shows a side view of a head-mountable assembly 300. The assembly 300 can be substantially similar to, including some or all of the features of, the head-mountable assemblies described herein, including assembly 100 and 200. The assembly 300 can include an HMD 304, a retention band 308, a mount 312, and an accessory 316.

In some examples, the retention band 308 can include multiple segments or sections and can even include multiple materials. In some examples, the retention band 308 includes an electrical connector 323 that the cable 324 plugs into to establish an electrical connection between the HMD 304 and the accessory 316. That is, a first end of the cable 324 can connect with the electrical connector 323 of the retention band 308, and a second end of the cable 324 can connect to an electrical connector 318 on the accessory 316. In the example that the accessory 316 is an auxiliary battery, the cable 324, via the electrical connector 323 can transfer power between the accessory 316 and an integrated battery 306.

In some examples, the mount 312 can include one or more arms or clips to retain the accessory 316. For example, the mount 312 can include an upper arm 314a that abuts, contacts, covers, or wraps around a top portion (as oriented in FIG. 3) of the accessory 316. The upper arm 314a can define a hook or L-shape such that the upper arm 314a engages at least two sides of the accessory 316. The upper arm 314a can stabilize the accessory 316 in at least one vertical direction. In some examples, the upper arm 314a can prevent the accessory from moving up relative to the retention band 308 and mount 312. In some examples, the L-shape of the upper arm can at least partially stabilize the accessory from moving away from the mount 312 (e.g., in a horizontal direction).

The mount 312 can include a side arm 314b that is configured to abut, contact, cover, or wrap around a side portion (as oriented in FIG. 3) of the accessory 316. The side arm 314b can define a hook or L-shape such that the side arm 314b engages at least two sides of the accessory 316. The side arm 314b can stabilize the accessory 316 in at least one horizontal direction. In some examples, the side arm 314b can prevent the accessory from moving sideways relative to the retention band 308 and mount 312. In some examples, the L-shape of the side arm can at least partially stabilize the accessory 316 from moving away from the mount 312 (e.g., in multiple horizontal directions). The mount 312 can include multiple side arms. For examples, the mount 312 can include a second side arm (not shown in FIG. 3) that is opposite the side arm 314b. When attached to the mount 312, the accessory 316 can be positioned between the side arms, thereby stabilizing the accessory along at least one horizontal axis.

The mount 312 can include a lower arm 314c that is configured to support, abut, contact, cover, or wrap around a bottom portion (as oriented in FIG. 3) of the accessory 316. The lower arm 314c can define a hook or L-shape such that the lower arm 314c engages at least two sides of the accessory 316. The lower arm 314c can stabilize the accessory 316 in at least one vertical direction. In some examples, the lower arm 314c can prevent the accessory from moving downward relative to the retention band 308 and mount 312. In some examples, the L-shape of the side arm can at least partially stabilize the accessory 316 from moving away from the mount 312 (e.g., in a horizontal direction). The lower arm 314c can be positioned opposite the upper arm 314a. When attached to the mount 312, the accessory 316 can be positioned between the upper arm 314a and the lower arm 314c to stabilize the accessory 316 along the vertical axis. In this manner, the mount 312 can form a type of cage for the accessory 316. Further details regarding means for attaching an accessory to the retention band 308 are discussed below.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4 shows a side view of select components of a head-mountable assembly 400. The assembly 400 can be substantially similar to, including some or all of the features of, the head-mountable assemblies described herein, including assembly 100, 200, and 300. The assembly 400 can include an HMD (not shown in FIG. 4), a retention band 408, a mount 412, and an accessory 416.

In some examples, the mount 412 can include movable arms (collectively arms 414). The arms 414 can be actuated or articulated between a closed position 414a and an open position 414b (represented in dashed lines). In the closed position 414a, the arms 414 can retain, secure, or hold the accessory 416 in place. In the open position 414b, the accessory 416 can be removed from the mount 412. In some examples, only one of the arms 414 is movable while the other remains fixed. In some examples, the arms 414 can be manually moved between the open position 414a and the closed position 414b. In some examples, the arms 414 automatically move between the open position 414a and the closed position 414b based on received input. For example, the mount 412 can include a sensor or actuator 411 that can detect when the accessory 416 is placed near or against the mount 412. In some examples, upon detecting that the accessory 416 is placed into/on the mount 412, the actuator 411 can trigger the arms 414 to move from the open position 414b to the closed position 414a. In some examples, the actuator 411 and arms 414 can be spring loaded such that when the actuator 411 is depressed or pushed in by the accessory 416, springs are released to actuate the arms 414 into the closed position 414a.

In some examples, the actuator 411 can be a sensor, such as a contact or pressure sensor that can detect a proximity of the accessory 411 and can subsequently produce a signal that triggers the arms 414 to close. As described herein, the accessory 416 can inductively transfer power to the mount 412 and/or HMD. Thus, in some examples, upon detecting the presence of the accessory through electromagnetic induction, the arms 414 can be signaled to the closed position 414a.

In some examples, the mount 412 can include one or more motors that actuate the arms 414. In some examples, the actuator 411 can be accessible for manual actuation by the user (e.g., on an exterior of the mount 412) even when the accessory 416 is being held by the mount 412. The actuator 411 can be any suitable button, toggle, switch, slide, cam, knob, or other actuation mechanism capable of allowing the user to move the arms 414 between the open position 414b and closed position 414a.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 shows a side view of select components of a head-mountable assembly 500. The assembly 500 can be substantially similar to, including some or all of the features of, the head-mountable assemblies described herein, including assembly 100, 200, 300, and 400. The assembly 500 can include an HMD (not shown in FIG. 5), a retention band 508, a mount 512, and an accessory 516.

In some examples, the mount 512 includes a magnet 514 that magnetically engages with a magnetic component 521 of the accessory 516. The magnet 514 can be internally or externally integrated with the mount 512. In some examples, the magnetic component 521 can be a magnet that is positioned in/on the accessory 516. In some examples, the housing itself of the accessory 516 serves as the magnetic component to attach to the magnet 514 (i.e., the accessory housing can interact magnetically.

In some examples, the mount 512 can include an electrical connector 519 configured to electrically connect with an electrical connector 518 of the accessory 516. The electrical connector 519 can be any suitable direction electrical contact, such as an Orion port. In some examples, the electrical connector 519 can act as both an electrical connection as well as an attachment feature. In other words, the electrical connector 519 can be incorporated with an attachment mechanism, such as the magnet 514 to simultaneously establish a physical and electrical connection with the accessory 516. The mount 512 can include circuitry (e.g., passing through the retention band 508) that established an electrical connection with the HMD. In this manner, the mount 512 can serve as an interposer or electrical bridge between the accessory 516 and the HMD. In some examples, the accessory 516 is a battery capable of inductively charging the mount 512 and consequently the HMD.

In some examples, the mount 512 can include an output component 510. The output component 510 can include multiple physically distinct or combined outputs. The output component 510 can include a variety of electrical components that produce an output (e.g., audio component, light module, haptic component, etc.) The output component 510 can alert the user to a status or state of the assembly 500. In some examples, the output component 510 can signal whether the mount 512 is connected (physically and/or electrically) to the accessory 516. Further details regarding output components is provided below with reference to FIG. 5.

The output component 510 can be a visual indicator that indicates a charging state or battery life of the accessory 516. For example, the output component 510 can include a plurality of lights, where the number of lights that are illuminated corresponds to a remaining battery life of the accessory 516.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

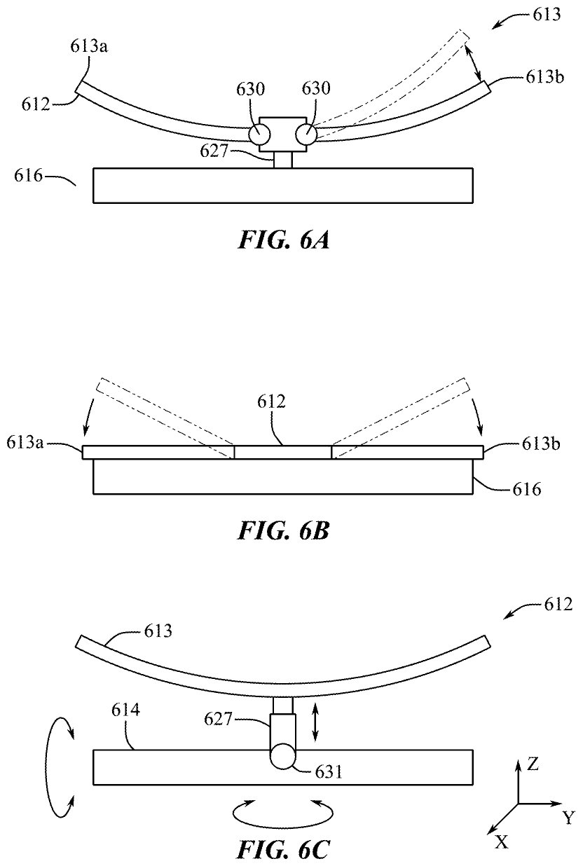

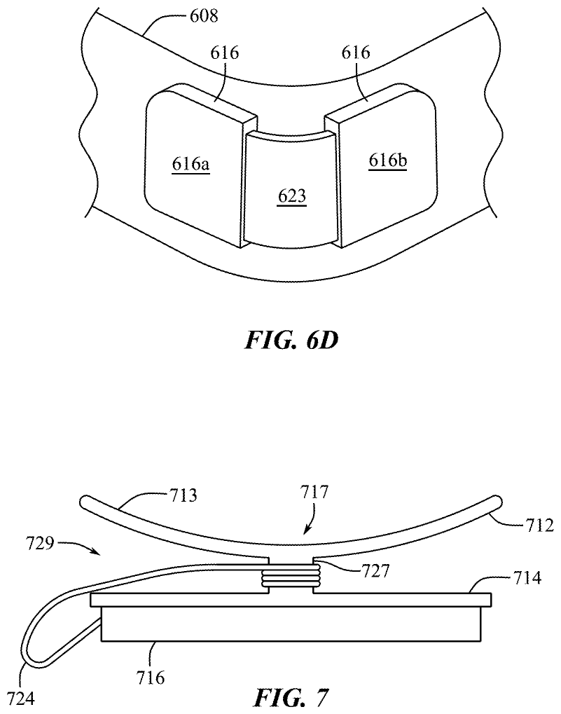

FIG. 6A shows a top view of a mount 612 and accessory 616. The mount 612 can be substantially similar to, including some or all of the features of, the mounts described herein, including mount 112, 212, 312, 412, and 512. Likewise, the accessory 616 can be substantially similar to, including some or all of the features of, the accessories described herein, including accessory 116, 216, 316, 416, and 516. In some examples, the mount 612 can include a coupler 613 to attach the mount 612 to the retention band of the HMD assembly (not shown in FIG. 6A). The coupler 613 can include a curved shape that conforms to the back of a user's head.

The coupler 613 can connect to the retention band via a mechanical and/or magnetic attachment mechanism. In some examples, the coupler 613 includes a recess or groove that receives the retention band. In some examples, the coupler 613 includes a clip or strap that attaches to the retention band. Further details regarding the attachment between the retention band and the mount are discussed below.

In some examples, the coupler 613 can include multiple arms 613a, 613b that are movable to conform to a user's head. In some examples, the arms 613a, 613b are connected to a central portion, column, or shaft 627 of the mount 612. The arms 613a, 613b can be connected to the shaft 627 via ball joints 630, hinges, or any other suitable attachment that enable movement of the arms 613a, 613b relative to the shaft 627. In some examples, the shaft 627 extends away from the user's head and coupler 613 such that a gap exists between the accessory 616 and the coupler 613. It will be understood that when not in use, the mount 612 can stay with the accessory 616 or can stay with the retention band of the HMD.

Any of the features, components, and/or parts, including the arrangements and configurations thereof shown in FIG. 6A can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6A.

FIG. 6B shows a side view of a mount 612. The mount 612 of FIG. 6B can be substantially similar to, including some or all of the features of, the mount 612 of FIG. 6A. In some examples, the arms 613a, 613b can be pushed substantially flat or flush against the accessory 616. For example, the arms 613a, 613b can be extended or deployed (as shown in dashed lines) in order to conform to a user's head when in use. The arms 613a, 613b can then be retracted when not in use. In some examples, the mount 612 and accessory 616 remain together when removed from the retention band. The mount 612 and accessory 616 can be a unitary component. In this manner, the mount 612 can be conveniently stored and transported with the arms 613a, 613b pressed flat against the accessory 616.

Any of the features, components, and/or parts, including the arrangements and configurations thereof shown in FIG. 6B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6B.

FIG. 6C shows a side view of a mount 612. The mount 612 of FIG. 6C can be substantially similar to, including some or all of the features of, the mounts 612 of FIGS. 6A and 6B. In some examples, the mount 612 includes a first coupler 614 for coupling to the accessory (not shown in FIG. 6C) and a second coupler 613 for coupling to the retention band (not shown in FIG. 6C). In some examples the first coupler 614 can be connected to the second coupler 613 by a shaft 627. The shaft 627 can be extend such that a distance between the first coupler 614 and the second coupler 613, and consequently a distance between the accessory and the back of the user's head, can be variable.

In some examples, the shaft 627 can be extended or contracted based on the user's preference. In some examples, the shaft 627 can be extended or contracted in order to improve the ability of the accessory to counterbalance the HMD. For example, the longer the shaft 627, the further the accessory will sit from the user's head, which in turn produces a greater counterbalance force on the HMD. In other words, increasing the length of the shaft 627 increases a length of a lever arm created by the weight of the mount 612 and the accessory. In some examples, the mount itself acts as the counterbalance (e.g., the first coupler 614 can instead merely be a weight or some other component fixed to the mount 612 and configured to produce a counterbalance for the HMD.

In some examples, the first coupler 614 is movable relative to the second coupler 613. In some examples, the first coupler 614 can be rotatable and/or translatable relative to the second coupler 613. The first coupler 614 can move via at least one of the shaft 627 or a pivot point 631. For example, the second coupler 613 can be stationary relative to the user's head, while the first coupler 614 can change its position relative to the user's head. In some examples, the first coupler 614 can move in any direction relative to the user's head, including in any of the X, Y, or Z plains of the Cartesian coordinate planes. Furthermore, the first coupler 614 can move or change its pitch, yaw, and roll relative to the second coupler 613. In some examples, the accessory can be oriented horizontally (i.e., with its longitudinal axis substantially horizontal) or vertically oriented (i.e., with it longitudinal axis substantially vertical).

Any of the features, components, and/or parts, including the arrangements and configurations thereof shown in FIG. 6C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6C.

FIG. 6D shows a rear perspective view of an accessory 616 attached to a retention band 608. In some examples, the accessory 616 can include a first battery 616a and a second battery 616b connected by a tether 623. In some examples, the tether 623 established an electrical connection between the first battery 616a and the second battery 616b. In some examples, the first battery 616a and the second battery 616b are separable connected to one another to form a single battery. In some examples, the assembly can include multiple modular batteries that can be stacked onto one another. In other words, the mount can support more than one accessory (e.g., auxiliary battery).

In some examples, the retention band 608 can be configured to accommodate for the user's hair style. For example, the retention band 608 can be bifurcated to accommodate for a bun or ponytail. In some examples, the retention band 608 can be separated between an open and closed state. In some examples, the retention band 608 can be split or separated to improve fit and securement of the HMD. The motion or state of the retention band 608 can signal one or more commands from the assembly (e.g., to begin charging using the batteries 616a, 616b).

Any of the features, components, and/or parts, including the arrangements and configurations thereof shown in FIG. 6D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6D.

FIG. 7 shows a top view of an accessory 716 and a mount 712, including a cable management system 750. The mount 712 can be substantially similar to, including some or all of the features of, the mounts described herein, including mount 112, 212, 312, 412, 512, and 612. Likewise, the accessory 716 can be substantially similar to, including some or all of the features of, the accessories described herein, including accessory 116, 216, 316, 416, 516, and 616.

In some examples, the mount 712 can include a cable management system 750 for managing or collecting excess length of a cable 724. In some examples, the cable management system 750 can include a central post or shaft 727, around which the cable 724 can be wrapped. It will be notes that the mount 712 can define a volume, space, or gap 729 between a first coupler 714, attachable to the accessory 716 and a second coupler 713, attachable to the retention band. The gap 729 can provide sufficient space to collect a substantial portion of the cable 724.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

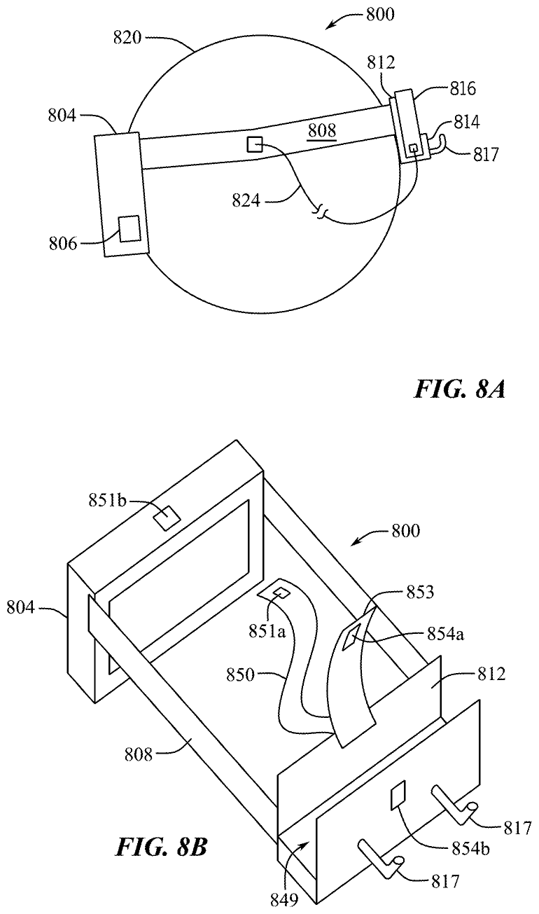

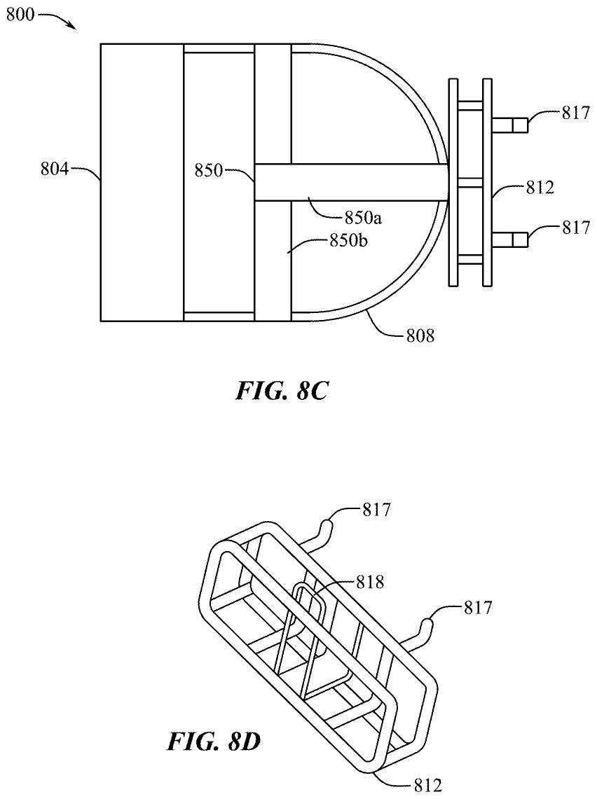

FIG. 8A shows a side view of a head-mountable assembly 800 worn by a user 820. The assembly 800 can be substantially similar to, including some or all of the features of, the head-mountable assemblies described herein, including assembly 100, 200, 300, 400, and 500, and mounts 612 and 712. The assembly 800 can include an HMD 804, a retention band 808, a mount 812, and an accessory 816. The accessory 816 can be electrically connected to a primary battery 806 of the HMD 804 via a cable 824.

In some examples, the assembly 800 can include a cable management system 817. The cable management system 817 can include a hook or hanger 817 that extends from a main body of the mount 812. The cable 824 can be wrapped around the hanger 817 to remove excess slack. In some examples, the mount 812 includes multiple hangers 817. The cable management system 817 can be used when the cable 824 is connected to the accessory and/or the HMD 804, but can also be used when the cable is not connected to either or both the accessory 816 and HMD 804. Further details regarding cable management systems are provided below.

Any of the features, components, and/or parts, including the arrangements and configurations thereof shown in FIG. 8A can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8A.

FIG. 8B shows a rear perspective view of the head-mountable assembly 800, and FIG. 8C shows a top view of the assembly 800. In some examples, the mount 812 can define a slot 849 for receiving the accessory. The mount 812 can include a fastener, belt, or strap 853 for securing the accessory. The strap 853 can include a connector 854a that can releasable attach to a connector 854b on the mount 812. The connectors 854a and 854b can be any suitable attachment mechanism, such as magnets, Velcro, snaps, loops, etc. The strap 853 can releasably secure the accessory in the slot 849. In some examples, the connector 854a is an electrical connector and the connector 854b is a hole in the body of the mount 812. The hole 854b can provide access to an electrical connector on the accessory. Thus, the strap 853 can simultaneously retain the accessory and establish an electrical connection using the strap 853.

In some examples, the mount 812 includes an over-the-head support 850 that extends between the mount 812 and the HMD 804, over the top of a user's head. The support 850 can work in concert with the retention band 808 to distribute at least some of the weight or load of the assembly 800 across the top of the user's head. The support 850 can further assist in stabilizing the assembly 800 on the user's head. As shown in FIG. 8C, the support 850 can include a first section 850a, that travels substantially from the back of the user's head toward the front of the user's head, and a second section 850b that travels or spans substantially from one side of the user's head to the other side of the user's head. The second section 850b can be connected to both the retention band 808 and the first section 850a.

In some examples, the support 850 includes a connector 851a that attaches to a corresponding connector 851b on the HMD 804. The connectors 851a and 851b can be any suitable attachment mechanism, such as magnets, Velcro, snaps, loops, etc. In some examples, the connectors 851a, 851b include electrical contacts to establish an electrical connection between the mount 812 and the HMD 804.

As also shown in FIG. 8D, the mount 812 can include a cable management system having multiple hangers 817. The hangers 817 can extends laterally from the mount 812 and can be spaced near opposing ends of the mount 812 to reduce the amount of winding a user must do in order to wrap up the cable. In some examples, the mount 812 can be positioned on the over-the-head support 850. In other words, the accessory can be positioned above the user's head instead of on the back of the user's head. In some examples, a first accessory can be positioned on the back of the user's head on the retention band 808, and a second accessory can be positioned above the user's head on the support 850. As shown in FIG. 8D, the mount 812 can include an anchor 818 for securing the first section 850a of the support 850 (see FIG. 8C) to the mount 812. In some examples, the mount 812 can be cage-like, having multiple non-continuous sections that expose the accessory. The exposed sections of the mount 812 can help to provide airflow and head dissipation of the accessory, and can also reduce material cost of producing the accessory.

Any of the features, components, and/or parts, including the arrangements and configurations thereof shown in FIGS. 8B and 8C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 8B and 8C.

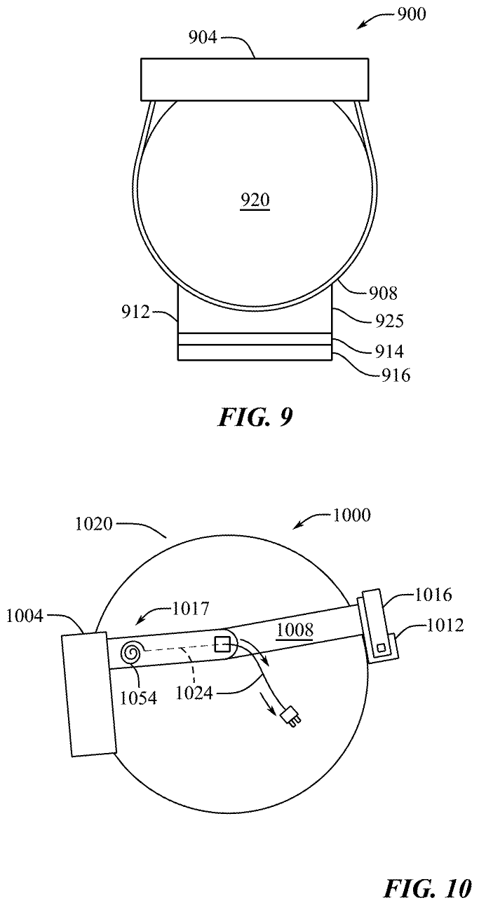

FIG. 9 shows a top view of a head-mountable assembly 900. The assembly 900 can be substantially similar to, including some or all of the features of, the head-mountable assemblies described herein, including assembly 100, 200, 300, 400, 500, and 800, and mounts 612 and 712. The assembly 900 can include an HMD 904, a retention band 908, a mount 912, and an accessory 916.

In some examples, the mount 912 can include a housing 925 and an attachment interface 914 for coupling with the accessory 916. The housing 925 can define an internal volume for management and storage of the cable. As described herein, the accessory can be spaced away from the user's head to form a space or volume. FIG. 9 illustrates how this space can be utilized for cable management. In some examples, the housing 925 can fully enclose the cable. In some examples, the housing 925 can house one or more electrical components or outputs. In some examples, the housing 925 defines a back volume for the speakers.

The housing 925 can define an opening or door to access the internal volume. In some examples, upon coupling the accessory 916 to the mount 912, the cable can be moved through an opening in the housing 925 to be stored in the internal volume. This can be done either while the cable is still attached to the accessory and HMD 904 or when the cable is detached and is capable of being entirely stored in the housing 925. In some examples, the accessory 916 can also be stored within the housing 925 such that the mount 912 is a self-contained enclosure.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

FIG. 10 shows a side view of a head-mountable assembly 1000 worn by a user 1020. The assembly 1000 can be substantially similar to, including some or all of the features of, the head-mountable assemblies described herein, including assembly 100, 200, 300, 400, 500, 800, and 900, and mounts 612 and 712. The assembly 1000 can include an HMD 1004, a retention band 1008, a mount 1012, and an accessory 1016.

In some examples, the HMD 1004 and/or the retention band 1008 can include an integrated cable management system 1017 for managing a power cable 1024. The cable management system 1017 can include a retraction device 1054 that can retract, reel, or spool the cable 1024. The retraction device 1054 can be a spring biased to pull against a direction of extension of the cable 1024. Thus, the cable 1024 can be biased in a contracted state, but can be extended or withdrawn in order to connect to the accessory 1016. The cable 1024 can be removably or permanently connected to the HMD 1004.

The retraction device 1054 is integrally formed within an interior of the retention band 1008. Likewise, the cable 1024 is at least partially stored within the retention band 1008. In some examples, the retraction device 1054 is positioned within the HMD 1004. In some examples, the retraction device 1054 is positioned on an exterior of the HMD 1004 and/or the retention band 1008. In some examples, the assembly 1000 can be charged using multiple battery accessories. For example, a first supplemental battery 1016 can be attached to the mount 1012 and can provide a direct or inductive charge through the mount 1012 as described herein. A second supplemental battery (not shown) can then be attached to the cable 1024 to establish a power transfer to the HMD 1004.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10.

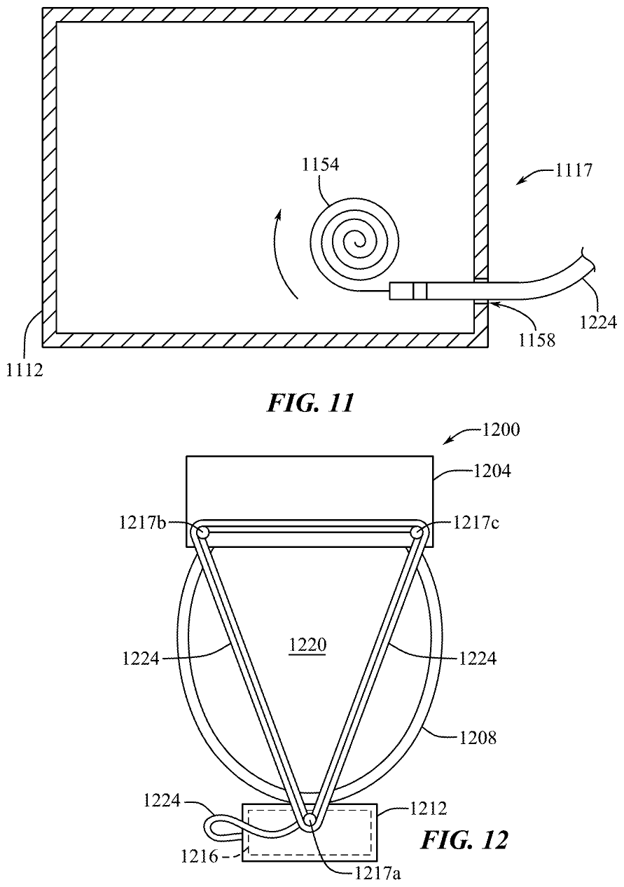

FIG. 11 shows a cross-sectional side view of mount 1112 including a cable management system 1117. The mount 1112 can be substantially similar to, including some or all of the features of, the mounts described herein, including mount 112, 212, 312, 412, 512, 612, 712, 812, 912, and 1012. In some examples, the cable management system 117 can include a retraction spring 1154 that can reel the cable 1124 into an internal volume of the housing 1112. The cable 1124 can be connected to the retraction spring 1154 through a port or opening 1158 in the mount 1112. The cable management system 1117 can include a spool, around which the cable can be wound. In some examples, at least some of the cable management system 1117, including the retraction spring 1154 or spool, can be positioned on an exterior of the mount 1112. In some examples, the spool is positioned on an exterior of the mount 1112 while the retraction spring is position in the interior volume of the mount 1112.

In some examples, the retraction device 1154 can automatically wind in response to receiving one or more inputs. For example, the retraction device 1154 can begin reeling in the cable 1124 in response to a sensor or actuator indicating that the accessory has been attached to the mount, for instance using the actuator 411 from FIG. 4. In some examples, the cable management system can include a manual spool that is twisted by the user to wind up the cable 1124. In some examples, the accessory includes a retraction device, such as an internal reel or spooling device to wind up the cable into a housing of the accessory 1116.

Any of the features, components, and/or parts, including the arrangements and configurations thereof shown in FIG. 6A can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 11.

FIG. 12 shows a top view of head-mountable assembly 1200. The assembly 1200 can be substantially similar to, including some or all of the features of, the head-mountable assemblies described herein, including assembly 100, 200, 300, 400, 500, 800, 900, and 1000. The assembly 1200 can include an HMD 1204, a retention band 1208, and a mount 1212 housing an accessory 1216.

The assembly 1200 can include a cable management system 1217a, 1217b, 127c (collectively 1217). The cable management system 1217 can include a plurality of pegs, about which a cable 1224 can be wound. Specifically, the cable management system 1217 can include a first peg 1217a positioned on the mount 1212, and a second peg 1217b and third peg 1217c positioned on the HMD 1204. As illustrated in FIG. 12, the cable 1224 can be wound around each of the pegs 1217 such that the cable 1224 is positioned over a user's head 1220. In some examples, the pegs 1217 can be specifically positioned such that the cable 1224 serves as an over-the-head support when wound around the pegs 1217. In some examples, the second peg 1217b and the third peg 1217c can be spaced apart from one another (e.g., proximate opposing edges of the HMD 1204. The distance between the second peg 1217b and third peg 1217c can determine the shape/configuration of the over-the-head support formed by the cable 1224. In some examples, the distance between the second peg 1217b and third peg 1217c can be tuned to enhance stability of the over-the-head support 1224. In some examples, the position of one or more of the pegs can be adjusted or customized by the user.

It will be understood that the number and position of pegs in the cable management system 1217 can vary. For example, there can be multiple pegs on the mount 1212 and only one peg on the HMD. In some examples, there can be only one peg on the HMD 1204 and one peg on the mount 1212. In some examples, there can be multiple pegs on the HMD 1204 and multiple pegs on the mount 1212.

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 12.

To the extent the present exemplary systems and methods use personally identifiable information, such use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description used specific, though exemplary, nomenclature to provide a thorough understanding of the described embodiments. It should be apparent to one skilled in the art that the specific details are not required in order to practice the described examples. Thus, the foregoing descriptions of the specific embodiments and examples described herein are presented for purposes of illustration and description only. They are not intended to be exhaustive or to limit the embodiments to the precise forms disclosed. Many modifications and variations are possible in view of the above teachings.

What is claimed is:

1. A head-mountable assembly, comprising:
a display unit;
a retention band;
a mount attachable to the retention band, the mount being movable relative to the retention band; and
an accessory attachable to the mount, the accessory being movable with the mount.

2. The head-mountable assembly of claim 1, wherein the accessory comprises a battery.

3. The head-mountable assembly of claim 1, wherein the accessory is magnetically attached to the mount.

4. The head-mountable assembly of claim 1, wherein the mount is extendable to increase a distance between the display unit and the accessory.

5. The head-mountable assembly of claim 1, wherein the mount comprises an output component.

6. The head-mountable assembly of claim 1, wherein the mount is integrally formed with the retention band.

7. The head-mountable assembly of claim 1, wherein the mount is integrally formed with the accessory.

8. A head-mountable device, comprising:
a display;
a support attached to the display and configured to retain the display on a user's head; and
an attachment feature configured to removably couple a battery to the support, the attachment feature positioned opposite the display.

9. The head-mountable device of claim 8, wherein the battery comprises a supplemental battery.

10. The head-mountable device of claim 8, wherein the attachment feature is removable from the support.

11. The head-mountable device of claim 8, wherein the attachment feature is movable to adjust a position of the battery.

12. The head-mountable device of claim 8, wherein the attachment feature comprises a cable management feature to retain a cable of the battery.

13. The head-mountable device of claim 8, wherein the attachment feature comprises:
a first electrical connector configured to establish an electrical connection with the battery; and
a second electrical connector configured to establish an electrical connection with the display.

14. The head-mountable device of claim 8, wherein the attachment feature defines an internal volume configured to house an electrical component.

15. The head-mountable device of claim 8, wherein the attachment feature comprises an over-the-head support.

16. A mount for an auxiliary battery of a head-mountable device, the mount comprising:
a cable management system;
a first attachment interface configured to attach the mount to a retention band of the head-mountable device; and
a second attachment interface configured to attach the auxiliary battery to the mount.

17. The mount of claim 16, wherein the cable management system comprises a retraction device configured to automatically retract the cable.

18. The mount of claim 16, wherein the second attachment interface is rotatable and translatable relative to the first attachment interface.

19. The mount of claim 16, wherein at least one of the first attachment interface or the second attachment interface comprises a magnetic attachment.

20. The mount of claim 16, wherein the second attachment interface is configured to attach to the auxiliary battery in response to the auxiliary battery being positioned against the mount.
